(19) United States
(12) Patent Application Publication
(10) Pub. No.: US 2025/0327473 A1
(43) Pub. Date: Oct. 23, 2025

(54) SYSTEMS, DEVICES, AND METHODS FOR LIMITER DEVICES

(71) Applicant: Spirol Industries Ltd., Windsor (CA)

(72) Inventors: Thomas J. Buchta, Cottam (CA); David N. Cazabon, St. Joachim (CA)

(21) Appl. No.: 18/871,012

(22) PCT Filed: Dec. 5, 2023
(86) PCT No.: PCT/CA2023/051609

§ 371 Date: Dec. 2, 2024

Related U.S. Application Data
(60) Provisional application No. 63/433,819, filed on Dec. 20, 2022.

(51) Int. Cl. F16B 19/02

(52) U.S. Cl. CPC F16B 19/02

(57) ABSTRACT

Embodiments described herein provide devices and methods for installation, the devices comprising: a body having a channel extending through the body and at least one feature in a wall of the body, the body having a top end and a bottom end. In some embodiments, the at least one feature comprises at least one notch and/or at least one opening. In some embodiments, the body includes a seam in the wall of the body. A fastener is secured in a host at the device by at least one retention tab engaged by at least one of the features.

### FIELD

The present specification relates generally to construction and, in particular, to fastener assemblies.

### BACKGROUND

Plastic objects are often manufactured in parts. Subsequently, the manufactured plastic components are assembled at joint sites, which may be held together by mechanical fasteners such as bolts.

### SUMMARY

In accordance with an aspect, a device for construction comprises: a body having a channel extending through the body and at least one feature in a wall of the body, the body having a top end and a bottom end.

In some embodiments, the channel has a hollow central passage extending through the body from the top end to the bottom end.

In some embodiments, the at least one feature includes at least one opening, each opening extending into the channel.

In some embodiments, the body further includes a seam at an outer wall of the body.

In some embodiments, the seam extends from the top end of the body to the bottom end of the body.

In some embodiments, the seam is an indent.

In some embodiments, the body is compressible radially by narrowing the width of the seam.

In some embodiments, the channel is configured to receive a fastener, the fastener having at least one tab configured to reside in the channel when installed in the channel.

In some embodiments, the seam is configured to receive a rib in a host.

In some embodiments, the at least one feature includes at least one notch defined along a perimeter of the top end of the body. In some embodiments, the at least one feature includes at least one notch defined along a perimeter of the top end or of both the top end and bottom end of the body.

In some embodiments, each notch is configured to receive a retention tab.

In accordance with an aspect, a limiter device includes: a cylindrical body, wherein the cylindrical body is defined by an outer surface and an inner surface and wherein the cylindrical body contains a hollow central passage; and a plurality of features that extend from the outer surface through to the inner surface.

In some embodiments, the plurality of features include a plurality of holes and wherein the plurality of holes are substantially circular. In some embodiments, the plurality of features include a plurality of holes and wherein the plurality of holes are substantially circular, square, or other shape.

In some embodiments, said plurality of features include a plurality of notches and wherein each notch is comprised of two sides parallel to the height of the cylindrical body and one side perpendicular to the height of the cylindrical body.

In some embodiments, the cylindrical body contains a vertical opening that extends along the height of the limiter device.

In accordance with an aspect, a method for construction includes: installing a body at a host by radially compressing the body and inserting the body into the host over at least one retention tab of the host, the body having a channel extending through the body, a seam through a wall of the body, and at least one notch defined along a perimeter of the top end of the body, each retention tab configured for retaining the body in the host at one of the at least one notch.

In accordance with an aspect, a method for construction includes: securing a fastener in material by: positioning a fastener in a channel extending through a body, the body having at least one opening in a wall of the body; and inserting the material through the body, the inserting comprising flowing the material through each opening and in the channel.

In some embodiments, the material is liquid molding plastic.

Other aspects and features according to the present description will become apparent to those ordinarily skilled in the art upon review of the following description of embodiments of the invention in conjunction with the accompanying figures.

### BRIEF DESCRIPTION OF THE DRAWINGS

The principles may better be understood with reference to the accompanying figures provided by way of illustration of an exemplary embodiment, or embodiments, incorporating principles and aspects, and in which:

FIG. 1 is a perspective view of a limiter, according to an embodiment;

FIG. 2A is a cross-sectional view of the limiter embedded within a plastic host and with a bolt held by the same limiter, according to an embodiment;

FIG. 2B is a top view of FIG. 2A, according to an embodiment; FIG. 3 is a perspective view of the limiter, according to an embodiment;

FIG. 4A is a top view of the limiter fitted onto a particular joint site of a plastic host and with a bolt held by the same limiter, according to an embodiment;

FIG. 4B is a cross-sectional view of FIG. 4A, according to an embodiment;

FIG. 5 is a perspective view of a limiter, according to an embodiment;

FIG. 6A is a top view of the limiter of FIG. 5 fitted onto a particular joint site of a plastic host, according to an embodiment;

FIG. 6B is a bottom view of the limiter of FIG. 6A, according to an embodiment;

FIG. 6C is a side view of the limiter of FIG. 5 fitted onto a joint site of a plastic host with a bolt, according to an embodiment;

FIG. 6D is a bottom view of a plastic host, according to an embodiment;

FIG. 6E is a limiter assembly, according to an embodiment;

FIG. 6F is a perspective view of the plastic host with two particular joint sites, according to an embodiment;

FIG. 7 is a schematic view of a limiter, according to some embodiments;

FIG. 8 is a photograph of other bolt and limiter assemblies; and

FIG. 9 is a photograph of a limiter assembled at a host.

### DETAILED DESCRIPTION OF EMBODIMENTS

The description that follows, and the embodiments described therein, are provided by way of illustration of an example, or examples, of particular embodiments. These examples are provided for the purposes of explanation, and not of limitation. In the description, like parts are marked throughout the specification and the drawings with the same respective reference numerals. The drawings are not necessarily to scale and in some instances, proportions may have been exaggerated in order more clearly to depict certain features.

Plastic objects are often manufactured in parts. Subsequently, the manufactured plastic components are assembled at joint sites, which may be held together by mechanical fasteners such as bolts. Bolts are often made of metal material. During the installation of bolts, the joint sites of plastic components are subject to increased pressure, and, as a result, compromise the integrity of the plastic components, leading to cracks at the joint sites that may further destabilized the entire plastic component. Therefore, a number of solutions to reinforce the joint sites of plastic components can be used.

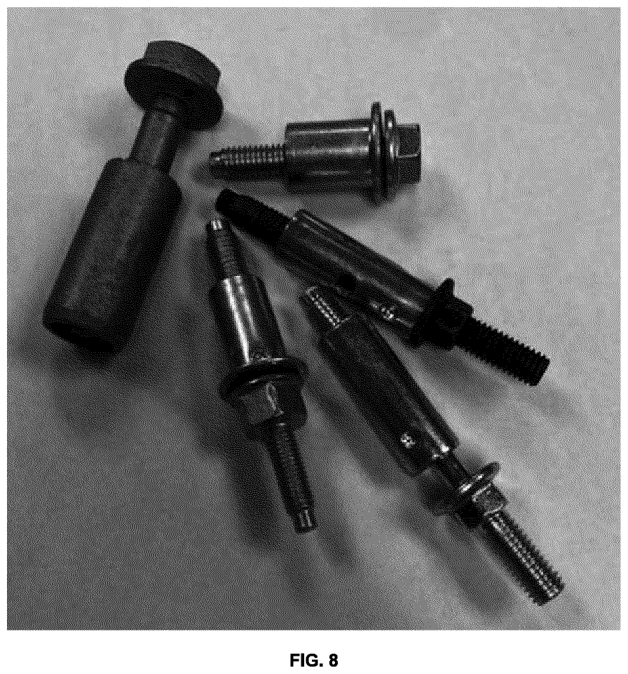

For example, the use of compression limiters that are compatible with the bolts used for assembly can be used for reducing the pressure on the joint sites of plastic components. Compression limiters, which can be made of metal, take on the compressive load generated from tightening of the bolts at joint sites. FIG. 8 shows example mechanically pre-assembled captive assemblies, including bolt and limiter combinations where bolts are mechanically attached to compression limiters. Other methods include the fitting of a plastic sleeve at the joint sites of plastic components to strengthen the joint sites and hold the bolts in place. For example, additional components, namely plastic sleeves called “axi rads”, can be used to hold bolts in place such as by installation in the limiter or hole or on the bolt. These methods often incur additional costs as they require the use of compression limiters or sleeves that are specific to the type of bolt used for assembly and/or specific to dimensions of the joint sites of the plastic components. Further, these methods require additional time to assemble the compression limiters or sleeves at the joint sites of plastic components or onto the bolts, or both. In some embodiments, limiter devices described herein allow for a reduction in cost and time by eliminating a third component and/or saves a customer from paying an assembly premium for the pre-assembled bolt/limiter assemblies. Assemblies formed using the limiters according to some embodiments allow a molder to mold in retention tabs in a host and create an assembly using only the limiter and bolt, with simple installation. A molder can create the tabs that retain the bolt reducing the axi rad (third component) or reduces the need to buy the part as pre-assembled product, for example. In some embodiments, a formed limiter is provided that allows the molder to create retention tabs to hold a bolt in place. For example, openings (e.g., holes), notches, and seam/slot features combined in a limiter can work in conjunction with core pin designs and/or molded tabs to create the retaining features, according to some embodiments.

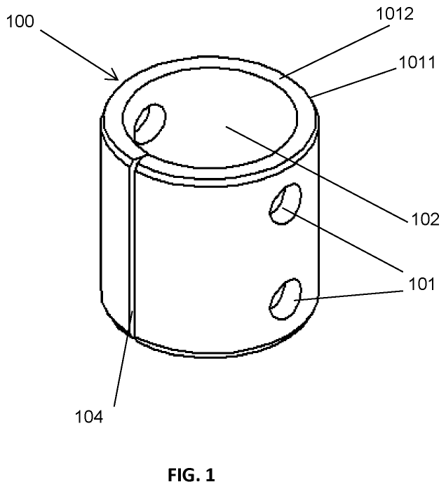

FIG. 1 shows an example limiter device 100, according to some embodiments. Limiter device 100 defines a channel 102 configured to receive a device, such as a fastener (e.g., a bolt), and includes at least one opening 101 defined in a wall of limiter device 100. Each opening 101 can allow material (e.g., liquid molding plastic) to flow through and allow for securing of limiter device 100 at a component (e.g., plastic component at which a fastener is subsequently installed). Channel 102 can extend through limiter device 100 or, in some embodiments, extend partway into limiter device 100. Channel 102 can also be referred to as a passage.

In the embodiment shown, limiter device 100 includes a cylindrical body. The cylindrical body can be formed from a single sheet of material shaped in a circular manner to form a cylinder. In some embodiments, the cross-section of the cylindrical body may be oval or of other suitable shape. The body is defined by an outer surface 1011 and an inner surface 1012. The body defines a channel 102, such as a hollow central passage. Limiter device 100 is of suitable dimension to fit within an injection mold. Within the injection mold, the limiter device 100 is retained in an upright position. Limiter device 100 includes a number of openings 101 (e.g., substantially circular holes; square holes; rectangular holes; polygonal shaped holes; holes of another shape(s)) that extend from the outer surface 1011 through to the inner surface 1012. In various embodiments, the number and configuration of openings 101 can be selected to accommodate attributes of the host and the type of device (e.g., fastener such as a bolt) to be held in place by the limiter device 100. The openings can be created during formation of limiter device 100 by removing material of a substantially circular shape (or other shape, in various embodiments) from the body of the limiter device 100. The limiter device 100 shown can be especially suited for hosts with joint sites that have smaller length to width ratios, for example.

In some embodiments, limiter device 100 includes seam 104 that extends a distance along limiter device 100. For example, in the embodiment shown, seam 104 extends along the cylindrical body from a top end to a bottom end. In some embodiments, seam 104 is sized and dimensioned to allow for alignment of limiter device 100 at the host, such as by facilitating alignment of openings 101. Seam 104 can be a vertical seam and extend through the wall of limiter device 100 or, in some embodiments, be defined as an indent in an outer surface of a wall of limiter device 100 that does not extend through the wall. Seam 104 can align with a notch 410 or other complementary component formed in or at host when installed at host.

FIG. 3 shows an example limiter device 300, according to some embodiments. Limiter device 300 does not include openings 101 in the body, but instead includes notches 301. In some embodiments, notches 301 are defined along one of limiter device's 300 perimeters (e.g., one of the two circular perimeters shown). In some embodiments, one or more notches 301 are defined along a top end of limiter device 300. In some embodiments, one or more notches 301 are defined along both a top end and a bottom end of limiter device 300. This can allow for limiter device 300 to be symmetrical for feeding and can make installation easier. For example, in some installations, notches on one end of limiter device 300 are not be used but do not have any negative effect either. In some embodiments, one or more notches 301 are defined along a bottom end of limiter device 300. Make: of Top end or Both Top and Bottom of the body.

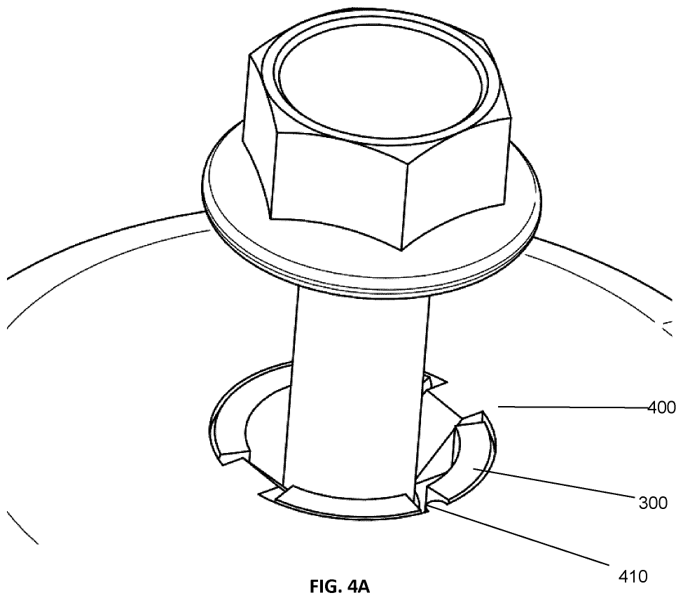

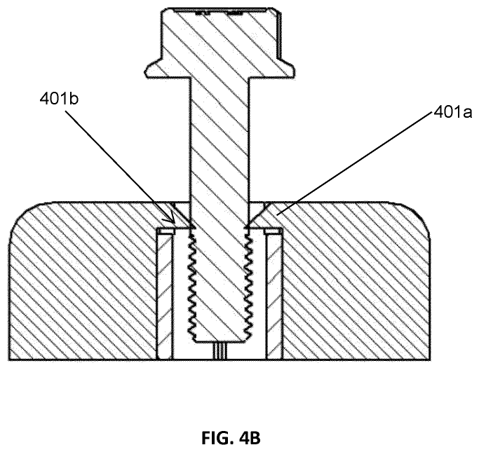

Each notch 301 is defined by two sides 302 parallel to the longitudinal axis of the limiter device 300 and one side 303 orthogonal to the longitudinal axis of limiter device 300. In some embodiments, when forming limiter device 300, notches 301 are created by removing material of the shape of the notch. In some embodiments, when forming limiter device 300, notches 301 are created by using a mold shaped to define notches 301. The limiter device 300 can be especially suitable for hosts (e.g., plastic hosts) with joint sites that are greater in depth (or length) than in width. In some embodiments, limiter device 300 can especially be suitable for hosts (e.g., plastic hosts) with joint sites that are smaller in depth (or length) than in width. The limiter device 300 can be especially suitable for hosts (e.g., plastic hosts) with joint sites that are equal in depth (or length) than in width. According to some embodiments, limiter device 300 is installed at the joint site of a host (e.g., a plastic host) by a downward force such that the limiter device 300 engages retention tabs 401 (e.g., 401a and 401b and, in some embodiments, one or more other retention tabs) as shown in FIG. 4A and FIG. 4B.

Limiter device 300 includes seam 304 that extends a distance along limiter device 300. For example, in the embodiment shown, seam 304 extends along the cylindrical body from a top end to a bottom end. In some embodiments, seam 304 is sized and dimensioned to allow for alignment of notches 301 with retention tabs 401 of the host. Seam 304 can be a vertical seam and extend through the wall of limiter device 300 or, in some embodiments, be defined as an indent in an outer surface of a wall of limiter device 300 that does not extend through the wall. Seam 104 can align with a notch 410 or other complementary component formed in or at host when installed at host.

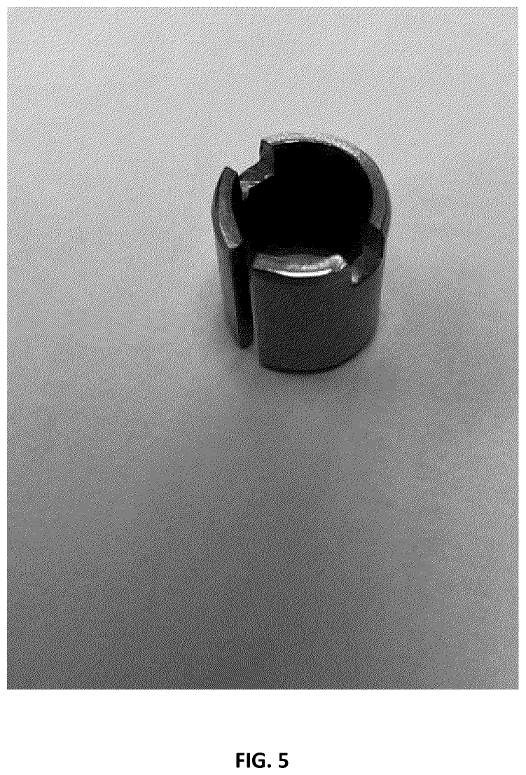

The dimensions of the sides 302, 303 of each of notches 301 and configuration of notches 301 can be selected based on various attributes of the host and the device (e.g., fastener such as bolt) used with limiter device 300. For example, in some embodiments, longitudinal axis of limiter device 300 can extend through a longer dimension of limiter device 300 than does an axis that is orthogonal to the longitudinal axis, such as shown in the example limiter device 300 of FIG. 3. In some embodiments, longitudinal axis of limiter device 300 can extend through a shorter dimension of limiter device 300 than does an axis that is orthogonal to the longitudinal axis, such as shown in the example limiter device 300 of FIG. 5. In some embodiments, the dimensions can be identical. A bolt can be retained in or by limiter device 300 at a host.

Limiter devices 100, 300 can be constructed from materials that provide sufficient strength to absorb at least some of the force of a fastener (e.g., bolt) during assembly of the construction using the host (e.g., plastic host). This can help maintain the integrity of the plastic host(s). Suitable materials can include stainless steel. Other factors, such as costs and size or function of the host may be used to base the choice of materials of the limiter devices 100, 300.

FIG. 4A shows a bolt installation at a component having an example limiter device 300 installed, according to some embodiments. In some embodiments, limiter device 300 is press-in version and especially suited to installation at products having a longer length than diameter, where there is enough radial retention to hold limiter device 300 in place. As shown, seam 304 is an open slot providing a slight compression when installed into the host receiving portion (e.g., host hole) (creating the radial retention) and provides an alignment aid, sliding over a small rib on the inside of the receiving portion of the host (e.g., host hole). This orientates notches 301, which slide over retention tabs 401 molded into the host (e.g., host hole), according to some embodiments.

In an embodiment, a combination of limiter devices 100, 300 with holes and/or with notches can be used in a single plastic host with numerous joint sites.

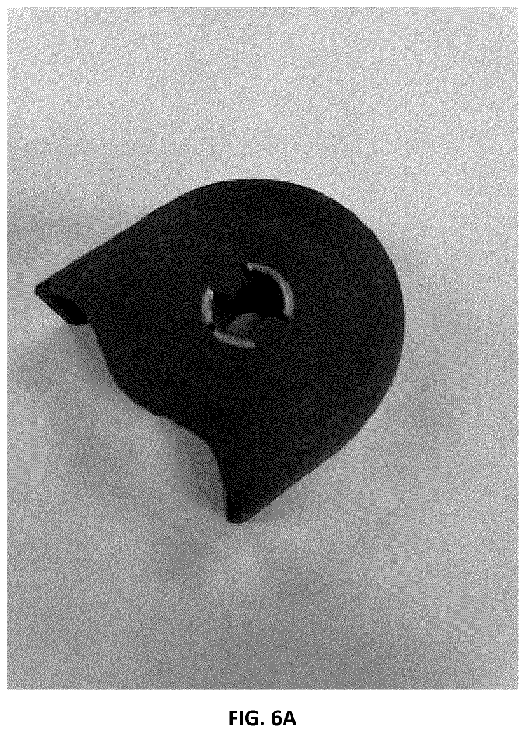

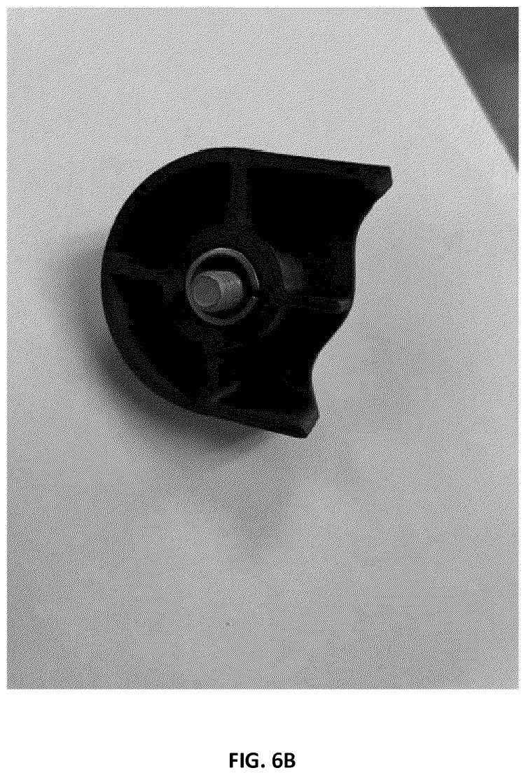

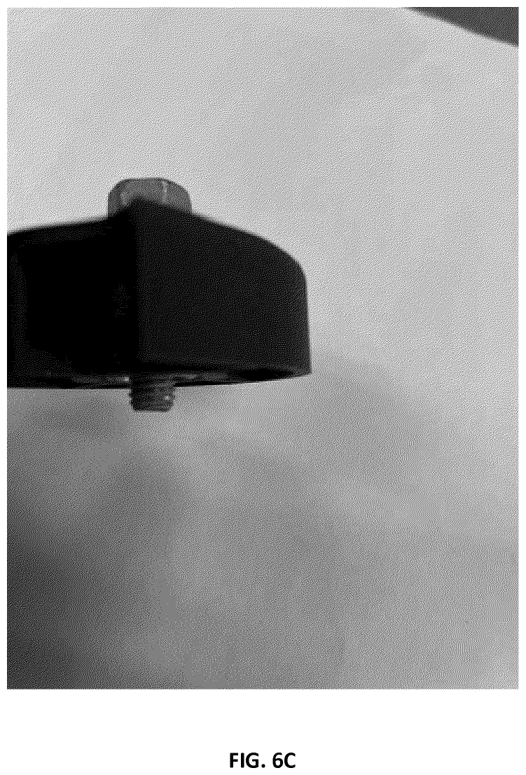

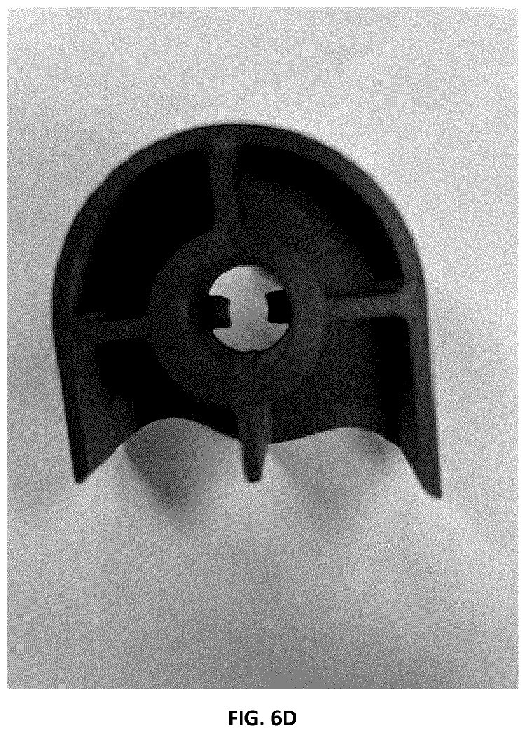

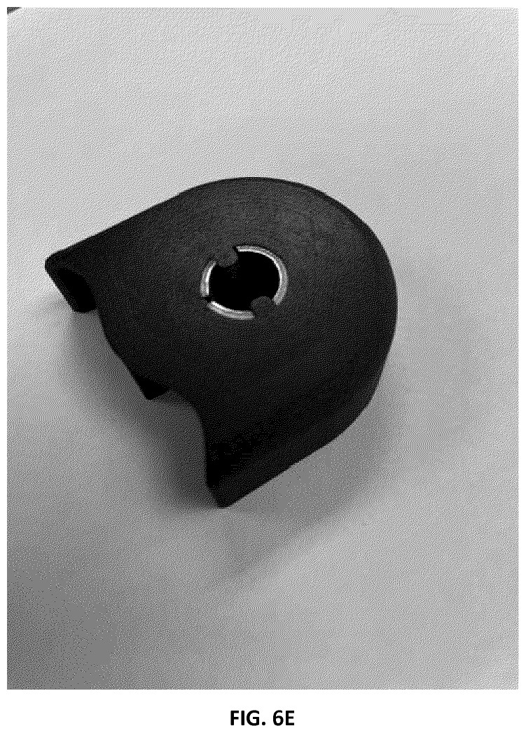

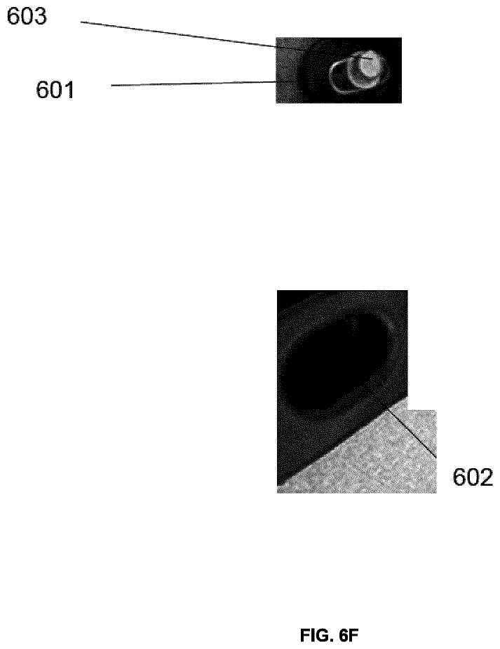

FIG. 6F shows a manufactured component (i.e., plastic host) containing joint sites 601, 602, at which they connect to other components (e.g., plastic components) via a bolt 603. As shown, the bolts are comprised of material such as metal and accordingly exert increased pressure on the joint site of the plastic host. In some embodiments, other materials can be used for the component and/or the bolt. To maintain the integrity of the host, a limiter device 100 (an example embodiment of which is shown in FIG. 1) is fitted at the joint sites prior to the installation of bolts, according to some embodiments. The limiter device 100 can be a roll formed compression limiter, for example.

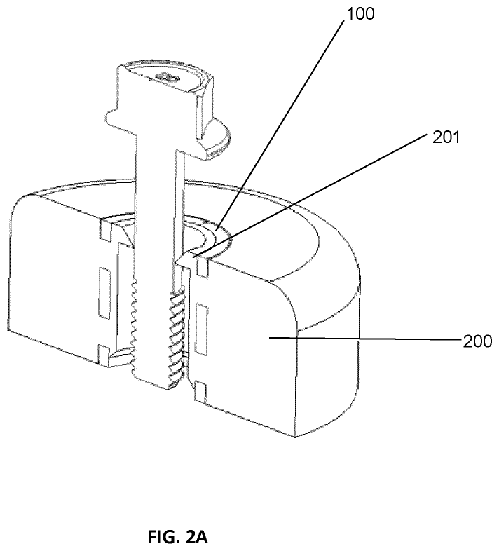

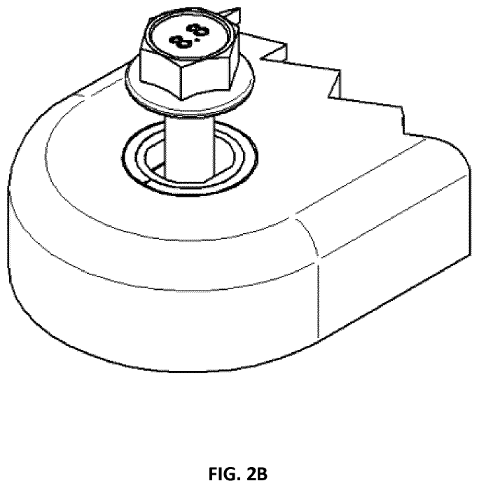

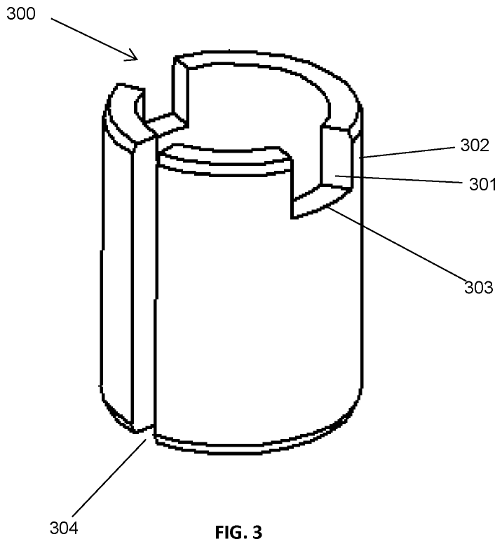

Limiter device 100 may be fitted contemporaneously with the manufacture of the host 200 (such as shown in an example embodiment in FIG. 2A) or fitted post-manufacture of the host 400 (such as shown in an example embodiment in FIG. 4A). FIG. 2A shows an example limiter device 100, according to some embodiments. This mold in version may be especially suitable for shorter length to diameter ratio parts where limiter retention is key, according to some embodiments. As shown, limiter 100 is placed in an injection mold with a core pin positioned over and within the hollow central passage 102 of the limiter device 100. An injection mold device releases liquid plastic that will flow around, within, and through the openings 101 of the limiter device 100. Hole configurations and/or numbers other than those shown in FIG. 2A can be included in different embodiments. Once the liquid plastic cools and turns into solid plastic, the mold is removed to reveal the plastic host 200 with the limiter device 100 embedded within it. In some embodiments, suitable material other than liquid plastic can be used. Within the limiter device 100 are retention tabs 201 formed by the liquid plastic that flowed through the holes of the limiter device 100. Different hole configurations and numbers, including positioning and orientation, can be selected to allow for formation of a desired tab configuration, such as to improve or tailor the security of the device. Retention tabs 201 can hold the bolts in place.

FIG. 2B shows a bolt installation at a component having an example limiter 100 installed, according to some embodiments. The limiter 100 is positioned over a core pin in an injection mold, and the machine injects plastic or other suitable material around the limiter and through the holes into the Inside Dimension (ID). The plastic or other material will also flow around the core pin. This core pin will have the tab configuration in it, so that plastic will flow into that configuration, making the retention tabs. Once the mold opens, the limiter is contained within the plastic part, with tabs left inside the limiter to hold the bolt once the bolt is received. The hole configuration could be two holes, four holes or any number of configurations.

In some embodiments, the host (e.g., plastic host) with the embedded limiter device 100 can be used to save time and money as additional limiters may not need to be purchased and additional time may not be required to fit a compression limiter device post-manufacture of the plastic host.

FIG. 4A shows an example limiter device 300, according to some embodiments. An example limiter device 300 is also depicted in FIG. 3, according to some embodiments. FIG. 4A shows limiter device 300 fitted at the joint site of the host 400 (e.g., plastic host) post-manufacture. The vertical opening 304 of the limiter device 300 acts as a guide to align the notches 301 with the retention tabs 401 of the plastic host 400.

FIG. 6A is a top view of an example limiter device 300 fitted onto a particular joint site of a plastic host, according to some embodiments. FIG. 6B shows a bottom view of this example limiter device 300. FIG. 6C shows a side view of limiter 300 fitted onto a particular joint site of the plastic host, according to some embodiment.

FIG. 6D and FIG. 6E shows an example host having features for receiving a limiter device 300, according to some embodiments.

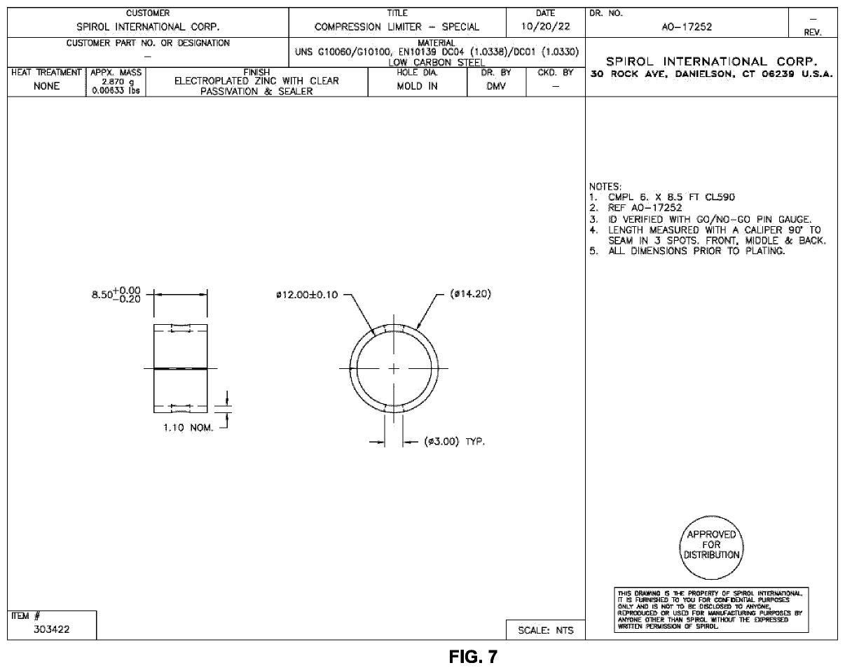

FIG. 7 shows a schematic view of example dimensions for an example limiter 100 or 300, according to some embodiments. For example, a width can be 8.50 mm+/−0.20, a seam width can be 3.00 mm, length measured from the top of a notch can be 14.20 mm, and length measured from the bottom of the notch can be 12.00+/−0.1. Limiter 100 and/or 300 can have different dimensions, according to various embodiments.

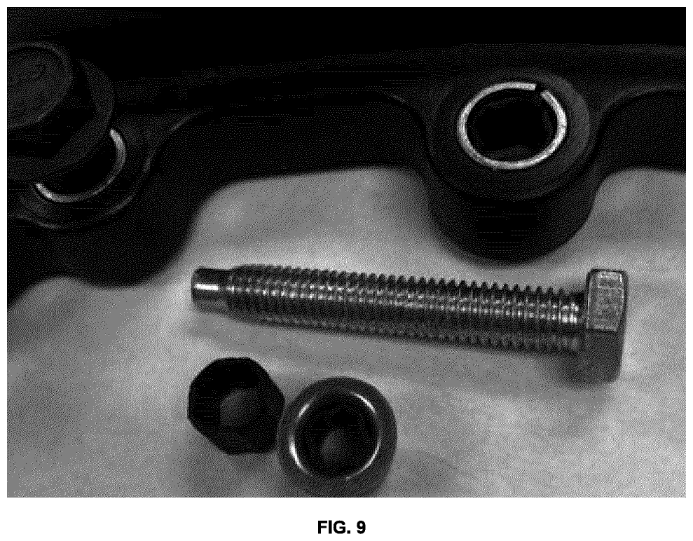

FIG. 9 shows an example installation of a limiter at a host. This can be replaced by a limiter device 300, according to some embodiments.

As used herein, a device is referred to as a limiter.

In some embodiments, an example device includes a body having a channel extending through the body and at least one feature in a wall of the body, the body having a top end and a bottom end. In some embodiments, the at least one feature comprises at least one notch and/or at least one opening. In some embodiments, the body includes a seam in the wall of the body. A fastener is secured in a host at the device by at least one retention tab engaged by at least one of the features. For example, the host can be formed from liquid plastic that is flowed through one or more openings in the wall of the body. When the liquid plastic cools around a fastener positioned in a channel of the body and when the liquid plastic cools in the opening(s) in the wall of the body, the fastener is retained in the cooled plastic host. In some embodiments, the fastener includes indent(s) or the like to allow the liquid plastic to form at least one retention tab in the indent so as to support its retention in the host. Materials other than plastic can be used. As another example, the device can be inserted into an already formed host such as by compressing the device radially. The formed host can have retention tabs at a top portion that prevent the device from sliding out of the formed host as these retention tabs are engaged by notch(es) formed in a top end of the body.

Various embodiments of the invention have been described in detail. Changes in and or additions to the foregoing description may be made.

1. A device for construction, the device comprising:
a body having a channel extending through the body and at least one feature in a wall of the body, the body having a top end and a bottom end.

2. The device of claim 1, the channel being a hollow central passage extending through the body from the top end to the bottom end.

3. The device of claim 1, the at least one feature comprising at least one opening, each opening extending into the channel.

4. The device of claim 1, the body further comprising a seam at an outer wall of the body.

5. The device of claim 4, wherein the seam extends from the top end of the body to the bottom end of the body.

6. The device of claim 4, wherein the seam is an indent.

7. The device of claims 4, wherein the body is compressible radially by narrowing the width of the seam.

8. The device of claim 1, wherein the channel is configured to receive a fastener, the fastener having at least one tab configured to reside in the channel when installed in the channel.

9. The device of claim 4, wherein the seam is configured to receive a rib in a host.

10. The device of claim 1, the at least one feature comprising at least one notch defined along a perimeter of the top end of the body.

11. The device of claim 10, each notch configured to receive a retention tab.

12. A limiter device, comprising:
a cylindrical body, wherein the cylindrical body is defined by an outer surface and an inner surface and wherein the cylindrical body contains a hollow central passage; and
a plurality of features that extend from the outer surface through to the inner surface.

13. The limiter device of claim 12, wherein the plurality of features comprise a plurality of holes and wherein the plurality of holes are substantially circular.

14. The limiter device of claim 12, wherein said plurality of features comprise a plurality of notches and wherein each notch is comprised of two sides parallel to the height of the cylindrical body and one side perpendicular to the height of the cylindrical body.

15. The limiter device of claim 4, wherein the cylindrical body contains a vertical opening that extends along the height of the limiter device.

16. A method for construction, the method comprising:
installing a body at a host by radially compressing the body and inserting the body into the host over at least one retention tab of the host, the body having a channel extending through the body, a seam through a wall of the body, and at least one notch defined along a perimeter of the top end of the body, each retention tab configured for retaining the body in the host at one of the at least one notch.

17. A method for construction, the method comprising:
securing a fastener in material by:
positioning a fastener in a channel extending through a body, the body having at least one opening in a wall of the body; and
inserting the material through the body, the inserting comprising flowing the material through each opening and in the channel.

18. The method of claim 17, wherein the material is liquid molding plastic.
